(19) United States
(12) Patent Application Publication
(10) Pub. No.: US 2023/0245140 A1
(43) Pub. Date: Aug. 3, 2023

(54) CONCURRENT TESTING OF MULTIPLE CREATIVES ACROSS MULTIPLE INDEPENDENT ONLINE PLATFORMS

(71) Applicant: Indeed, Inc., Austin, TX (US)

(72) Inventors: Shichuan Ma, Dublin, CA (US); Fengdan Wan, San Jose, CA (US); Ziying Liu, San Carlos, CA (US); Yu Sun, Santa Clara, CA (US); Haiyan Luo, Sunnyvale, CA (US)

(73) Assignee: Indeed, Inc., Austin, TX (US)

(21) Appl. No.: 17/588,110

(22) Filed: Jan. 28, 2022

(51) Int. Cl. G06Q 30/02

(52) U.S. Cl. CPC G06Q 30/0201; G06Q 30/0242

(57) ABSTRACT

A multiple platform, multiple creative testing system and method implement and utilize devices and processes for managing and implementing testing of multiple creatives across multiple independent online platforms. The system and method enable a provider of creatives to perform testing of multiple creatives, such as A/B testing, across multiple online platforms with an A test targeting a control group of targeted individuals and an independent B test concurrently targeting a disjoint test group of targeted individuals across multiple online platforms. The system and method accomplish testing through concurrently using two independent targeted tests utilizing separate creatives to disjoint groups of targeted individuals across multiple online platforms. By controlling membership of targeted individuals in groups across multiple online platforms concurrently and tracking and correlating responses, the system and method reliably evaluate the effectiveness of the creatives by ensuring the integrity of the results across the multiple online platforms.

### BACKGROUND

### Technical Field

The present invention relates generally to online testing, and more specifically to a computer implemented method and system for concurrent online testing of multiple creatives across multiple independent online platforms.

### Description of Related Art

Online advertising on the internet has and continues to proliferate over time. Advertisers, such as companies and other entities, may utilize on-line advertising on their websites as well as on the website of other creative providers such as email providers, social media providers, search engine providers, other third party content and shopping providers, etc. Such advertising may be implemented through the use of targeted emails, pop-up or pop-down ads, webpage embedded ads, etc. A highly developed ecosystem of online advertising providers and associated software tools has been utilized in this proliferation of online advertising.

Advertisers desire to use the most effective advertisements and, thus, regularly develop and test new advertisements. A/B testing is common way of testing two different advertisements, i.e. advertisement A and advertisement B. A company may utilize online A/B testing to determine the more effective type of advertising for a given target group of targeted individuals. Online A/B testing may also be utilized to identify whether certain changes to advertising may improve an ongoing advertising campaign, to identify whether a variation of online content may positively or negatively affect certain desired targeted individual responses, or to identify whether certain changes to online content may impact modeled targeted individual behavior. Online A/B testing is essentially a randomized controlled experiment in which two groups (group A and group B) of a sampled population are exposed to either a first online content or a second online content, respectively. Certain metrics are tracked during the online A/B test and any variation in those metrics between group A and group B can be statistically determinative of the effectiveness differential between the first and second online content being tested.

Various online platforms will perform online A/B testing on behalf of an advertiser or other creative provider to targeted individuals. The advertiser may provide a first online content and a second online content to an online platform to conduct A/B testing to targeted individuals meeting a target profile or otherwise identified while also providing certain metrics for monitoring the targeted individual's response to the provided online content. The online platform can then identify a sample of their targeted individuals meeting the target profile, randomly segregate the samples targeted individuals into a group A and a group B, run the A/B testing on those groups, and report the resulting metrics of the A/B testing back to the advertiser or other creative provider. Based on the results of the A/B testing, the creative provider can make an informed decision regarding which online content to utilize for effective targeted advertising for that online provider.

### SUMMARY

A method, system and/or computer usable program product for performing A/B testing of first and second creatives across multiple, independent online platforms sending the first and second creatives for distribution across the multiple, independent online platforms; sending a first request to each of the online platforms to provide the first creative only to computer systems associated with individuals of a first test group set; sending a second request to each of the online platforms to provide the second creative only to computer systems associated with individuals of a second test group set, wherein the first test group set and the second test group set are disjoint and the first request is independent of the second request; receiving responses to the first and second creatives; receiving tracking data that links each response to one of the individuals in either the first test group set or the second test group set; for each of the responses, processing the tracking data to generate a link between each individual and either the first creative or the second creative; and evaluating the links to determine an effectiveness of the first and second creatives.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings.

FIG. 1 depicts a block diagram of a creative provider managing and implementing A/B testing across multiple independent online platforms, in which various embodiments of the present disclosure may be implemented.

FIG. 2 depicts a flow diagram of the creative provider managing and implementing A/B testing across multiple independent online platforms, in which various embodiments of the present disclosure may be implemented.

FIGS. 3A-3B depict block diagrams of a targeted individual database and a targeted individual cross-index database, in which various embodiments of the present disclosure may be implemented

FIG. 4 depict a diagram of a user interface 400 utilizing a use case for implementing an A/B test, in which various embodiments of the present disclosure may be implemented.

FIG. 5 depicts a block diagram of a creative provider in communication with online platforms and service providers, in which various embodiments of the present disclosure may be implemented, in which various embodiments of the present disclosure may be implemented.

FIGS. 6A, 6B, and 6C collectively depict a flow diagram of the creative provider managing and implemented A/B testing across multiple independent online platforms, in which various embodiments of the present disclosure may be implemented.

FIG. 7 depicts a block diagram of an illustrative data processing system in which various embodiments of the present disclosure may be implemented.

FIG. 8 depicts a block diagram of an illustrative network of data processing systems in which various embodiments of the present disclosure may be implemented.

### DETAILED DESCRIPTION

Embodiments of a multiple platform, multiple creative testing system and method implement and utilize devices and processes for managing and implementing testing of multiple creatives across multiple independent online platforms as explained with reference to the various embodiments below. A “creative” is content in any media format, e.g. print, audio, video, or a combination thereof, that is presented to user of a computer system with the intention of promoting such as promoting an entity (such as a company, organization, or individual), a cause, a political candidate, awareness of an issue, event, or other item of interest such as an advertisement for the sale of goods and/or services.

A/B testing represents testing of two creatives, an A creative and a B creative. However, the techniques below discussing A/B testing apply to testing any number of multiple creatives for disjoint groups whose group membership is maintained across multiple platforms. In other words, creatives 1-N can be sent to disjoint groups 1-N across multiple platforms, where N is an integer greater than or equal to 2, and “disjoint groups” means that each member of a group is member of that group and only that group.

Contemporary advertising portals and brokers control target group constituencies for A/B testing. For example, conventionally if “Company” sends an advertisement A and B for A/B testing to two advertising portals, such as Facebook or Google, the first portal will send advertisement A to group 1 and advertisement B to group 2. Likewise, the second portal will send advertisement A to group 3 and advertisement B to group 4. Members of groups 1 and 3 will most likely be the same, and members of groups 2 and 4 will most likely not be the same. So, if (i) person-1 is a member of group 1 for the first portal and a member of group 4 in the second portal, (ii) person-1 responds to an advertisement, (iii) the portals do not track whether person-1 responded to advertisement A or B or both, and (iv) the “Company” that advertised cannot technologically determine whether person-1 responded to advertisement A or advertisement B. Without the capability of controlling A/B testing of creatives within disjoint groups across multiple platforms, the effectiveness of A and B creatives cannot be precisely determined. The multiple platform, multiple creative testing system and method discussed herein provides a technological solution that enables multiple creative testing by, among other things, employing a combination of technology to ensure disjoint grouping across multiple platforms and link responses to creatives to specific members of the disjoint groups.

Thus, in at least one embodiment, multiple platform, multiple creative testing system and method provides a provider of creatives to perform creative testing, such as AB testing, across multiple online platforms with an A test targeting a control group of targeted individuals across multiple online platforms and an independent B test concurrently targeting a disjoint test group of targeted individuals across the multiple online platforms. The system and method accomplish multiple creatives testing through concurrently using two independent targeted tests utilizing separate creatives to disjoint groups of targeted individuals across multiple online platforms. That is, a first targeted test utilizes a first creative with a control group of targeted individuals across multiple online platforms and a second independent targeted test concurrently utilizes a second creative with a disjoint test group of targeted individuals across the same online platforms. By controlling membership of targeted individuals in groups that have a common membership across multiple online platforms concurrently and tracking and correlating responses to separate tests, the system and method enable the creative provider to reliably evaluate the effectiveness of the creatives by ensuring the integrity of the results, i.e. essentially comparing “apples to apples, oranges to oranges” across the multiple online platforms.

The multiple platform, multiple creative testing system and method represent technological improvements in at least utilization of content distribution, online platforms, tracking and correlating information and responses to multiple, distributed creatives across multiple platforms and multiple groups of targeted individuals. The multiple platform, multiple creative testing system and method alter the contemporary utilization of computing platforms by, for example, separating distribution of creatives to the online platforms to multiple targeted groups while maintaining a consistent, identical membership in disjoint groups across the platforms, tracking responses, and correlating responses to members of the groups, and, thus, accurately determining relative effectiveness of each creative. Thus, the system and method counterintuitively separate joint testing of creatives while utilizing improving the organization and utilization of technology to allow for the correlation of responses and determining accurate results.

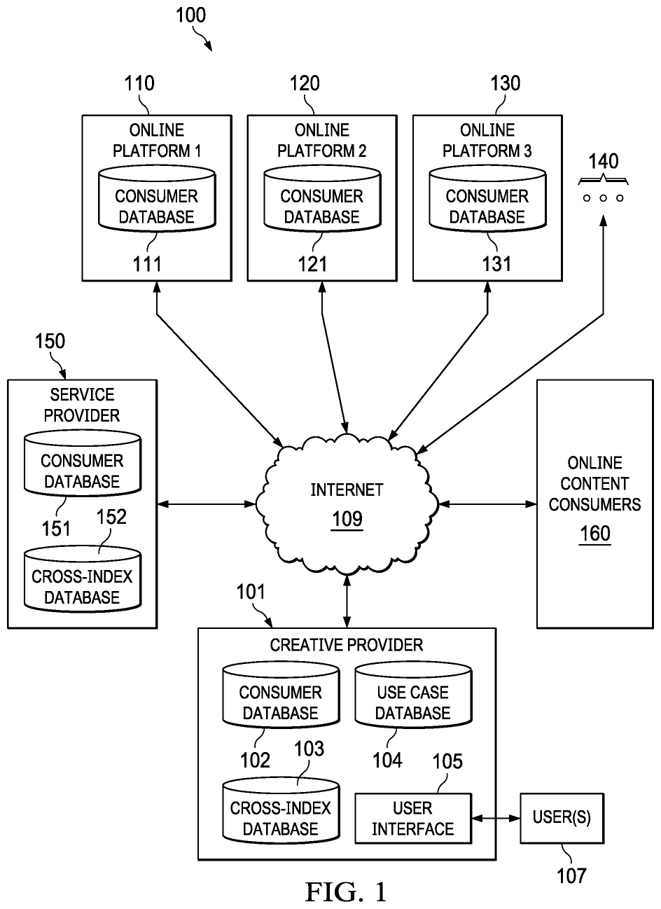

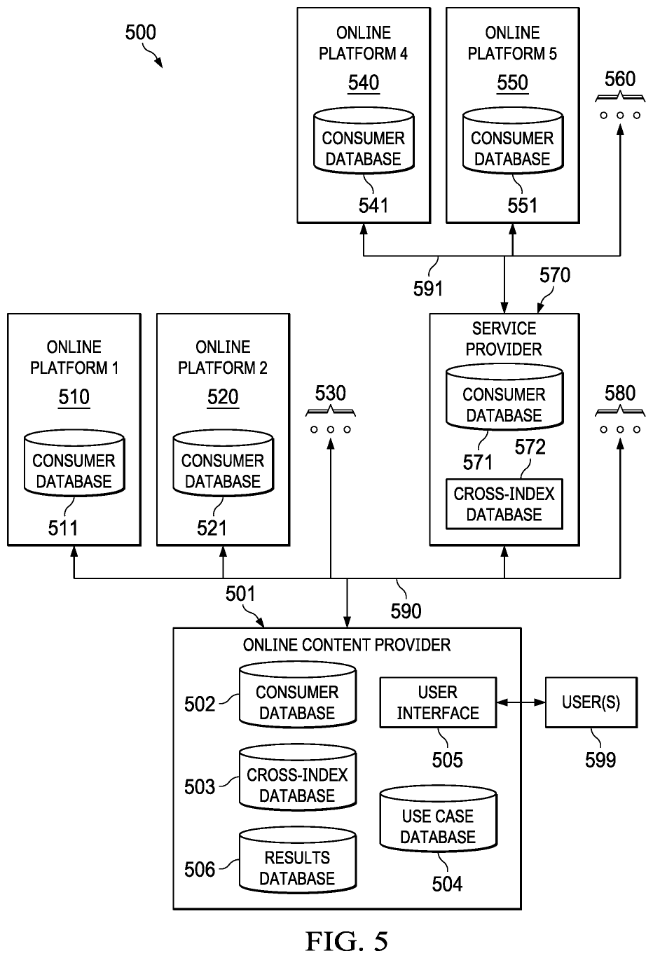

FIG. 1 depicts a block diagram 100 of creative provider 101 managing and implementing A/B testing across multiple independent online platforms, in which various embodiments of the present disclosure may be implemented. Online creative provider 101 may communicate with multiple online platforms 110, 120, and 130 (also referred to herein as publishers) across internet 109. Creative provider 101 may also communicate with additional online platforms 140 across internet 109. Creative provider 101 may also communicate with some of online platforms 110, 120, 130, and 140 through service provider 150 across internet 109. Furthermore, online platforms 110, 120, 130, and 140 as well as service provider 150 and creative provider 101 may communicate with a variety of online content targeted individuals 160 across internet 109. As described herein, targeted individuals are online users that may access or otherwise view online content submitted by creative provider 101 and transmitted to the targeted individuals by online platforms 110, 120, 130, and 140 creative provider. Communications between online provider 101 and selected online platforms (e.g., online platform 110 and 120) as well as with service provider 150 may be more tightly coupled through the use of previously developed communication channels. Similarly, communications between service provider 150 and selected online platforms (e.g., online platforms 130 and 140) may also be more tightly coupled through the use of previously developed communication channels. Such communication channels are discussed in greater detail below with reference to FIG. 5. Although all online communications are shown to be across the internet in the present embodiment, alternative embodiments may utilize other types of online networks to enable these communications such as mobile phone networks, cable networks, etc.

In addition to creative provider 101, online platforms 110, 120, 130 and 140 may also be creative providers to targeted individuals 160. For example, online platforms 110, 120, 130 and 140 may be social media platforms, search engine providers, other third party content and shopping providers, or other types of publishers providing content to targeted individuals 160. As a result, each online platform may have their own set of targeted individuals that are tracked in corresponding targeted individual databases 111, 121, 131, etc. Each targeted individual database may track information specific to the corresponding online platform such as a unique identifier for that targeted individual, profile information for that targeted individual, and online activity information of that targeted individual for the corresponding online platform. For example, a social media platform may obtain targeted individual profile information directly from the targeted individual as well as track certain online preferences for that targeted individual. This information may be gleaned from the online activities of the targeted individual with the online platform as well as any other information which may be gleaned from the authorized use of cookies and other typical information gathering techniques known in the industry. Online platforms 110, 120, 130 and 140 may be considered independent from each other if they are owned and/or managed independently and they include separately managed targeted individual databases. Due to the use of cookies and other information gathering techniques, the online platforms may inevitably include some common targeted individuals and information about those targeted individuals despite being independently managed.

Online platforms 110, 120, 130 and 140 may also provide selected content to targeted individuals 160 through advertising channels such as service provider 150. Online creative provider 101 creative provider maintains a targeted individual database 102 of its targeted individuals. Targeted individual database 102 tracks information specific to the creative provider 101 such as a unique identifier for that targeted individual, profile information for that targeted individual, and online activity information of that targeted individual with creative provider 101. Creative provider 101 may also maintain a cross-index database 103 that includes information correlating targeted individuals across the various creative providers and online platforms. Cross-index database 103 may be developed over time through the authorized use of synchronizing cookies and other typical information gathering techniques known in the industry. Creative provider 101 may include a use case database 104 and user interface 105 for implementing A/B testing by user(s) 107. User(s) 107 may be user internal to creative provider 101, external suppliers working on behalf of creative provider 101, or other similarly authorized individuals. Use case database 104 includes a set of predefined use cases of population segments meeting certain criteria. A use case may be developed for each advertising campaign. Alternatively, rather than developing a new use case for each for each A/B test, a predefined use case with a given population segment may be modified and/or supplemented by user 107 for utilization by subsequent A/B tests. A set of these use cases may be generated and stored in use case database 104 for such utilization. User(s) 107 may then utilize user interface 105 to implement A/B testing, thereby reducing the time and expertise needed by the user(s) for implementing such A/B testing such as described in greater detail below. User(s) 107 may be, for example, an employee of creative provider 101.

Service provider 150 provides linkages between creative providers and various online platforms. That is, creative provider 101 may request targeted advertising through service provider 150 to selected online platforms, such as online platforms 120 and 130. Service provider 150 may be an on-line ad placement agency, a demand—side platform (DSP) that links advertisers with publishers referred to as supply-side platforms (SSPs), a tracking entity that can cross-correlate targeted individuals across multiple online platforms, etc. Service provider 150 may include a targeted individual database 151 that includes information about targeted individuals as well as a cross-index database 152 that correlates targeted individuals among the various creative providers and online platforms. This information may be utilized in enabling creative provider implementing A/B testing across multiple independent online platforms as described below.

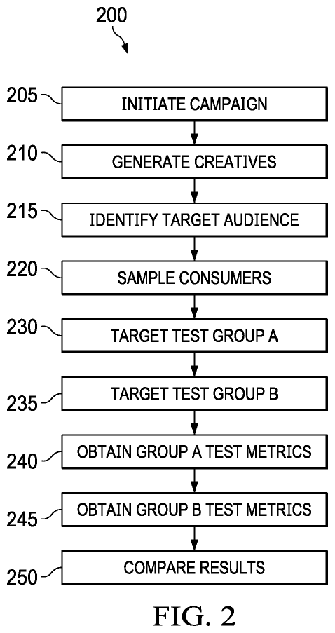

FIG. 2 depicts a flow diagram 200 of the creative provider 101 managing and implementing A/B testing across multiple independent online platforms in which various embodiments of the present disclosure may be implemented. This process may be managed by user(s) 107 through user interface 105 utilizing use case database 104 and underlying targeted individual database 102 and cross-index database 103. FIG. 2 is described herein with reference to elements of FIG. 1.

In a first step 205, an online advertising campaign, or other campaign intending to generate a targeted individual response on selected online platforms 110, 120, 130 or 140, is initiated by creative provider 101. This online advertising campaign may be implemented directly from creative provider 101 to the online platforms, indirectly through service provider 150, or a combination thereof. This campaign may include a target audience of targeted individuals which meet a predetermined profile including certain predefined criteria such as age, prior online activity or lack thereof, etc. This campaign may also include a desired targeted individual response to the advertising campaign including certain quantifiable metrics such as the targeted individual clicking on the creative for additional information, the targeted individual buying or applying for certain goods, services or employment after viewing the creative, etc. This response by the targeted individual may be directly from or through any platform 110, 120, 130 or 140 that is displaying the creative to the targeted individual or it may be a separate response by the targeted individual directly to creative provider 101. Although the present embodiment is directed to initiating an online campaign, it may also be directed to improving or modifying an existing online campaign.

Then in step 210, a pair of test creatives, referred to herein as a control creative and a test creative, are generated or obtained by creative provider 101 for testing with a sample of the target audience for the desired targeted individual response. This may include two different advertisements to determine the more effective advertisement, variations of the same advertisement (e.g., different background colors, different voices, etc.) to determine the more effective variation, or even an advertisement and a placebo (e.g., a public service announcement and a test advertisement) to determine the overall effectiveness of the advertisement. If more than two creatives are intended for testing, then multiple A/B tests may be run concurrently with disjoint samples of the target audience.

In step 215, a target audience of targeted individuals, referred to herein as a targeted segment, is identified by creative provider 101. That is, the targeted segment of the population of targeted individuals meeting the predefined profile is identified based on certain predefined criteria from step 205. The targeted segment may also be further limited to those targeted individuals that are also in the targeted individual databases of the selected online platforms 110, 120, 130 and 140, as determined through the utilization of cross-index database 103. In the present embodiment, this targeted segment may be identified from targeted individual database 102 of creative provider 101. In an alternative embodiment, this targeted segment may be identified by utilizing the services of service provider 150 and its targeted individual database 151 and cross-index database 152. Multiple targeted segments may be previously identified and stored as predefined segments.

In step 220, the targeted individuals identified in the targeted segment are randomly sampled and segregated by creative provider 101 into two groups for the A/B testing. This sampling may include further filters on the targeted individuals such as limiting the sampling to targeted individuals in certain countries. In addition, the size and relative proportions of the sampling is also set forth by creative provider 101. For example, the creative provider may designate a sample size of 1000 targeted individuals in a 10/90 split between group A (also referred to herein as the control group) and group B (also referred to herein as the test group) resulting in 100 targeted individuals in the control group and 900 targeted individuals in the test group, the groups being disjoint sets of targeted individuals. The sample size and proportions may be determined based on the level of statistical significance sought for the A/B test as well as other factors such as described herein.

In step 230, creative provider 101 requests multiple selected online platforms 110, 120, 130 or 140 to perform a first targeted test of the targeted individuals identified in the control group (group A) with the control creative with instructions to track and provide back certain metrics trackable by the corresponding online platform. In this embodiment, cross-index database 103 is utilized to identify identifiers of the control group targeted individuals for each online platform. As described above, an alternative embodiment may utilize service provider cross-index 152 for identifying identifiers of the control group targeted individuals for selected online platforms. In step 235, creative provider 101 also requests multiple selected online platforms 110, 120, 130 or 140 to perform a second targeted test of the targeted individuals identified in the test group (group B) with the test creative with instructions to track and provide back certain metrics trackable by the corresponding online platform. In this embodiment, cross-index database 103 is utilized to identify identifiers of the test group targeted individuals for each online platform. As described above, an alternative embodiment may utilize service provider cross-index 152 for identifying identifiers of the test group targeted individuals for selected online platforms. The request described in step 230 is communicated independently from the request described in step 235, but the first and second targeted tests are typically initiated concurrently with the same selected online platforms to help eliminate statistical variations caused by timing and the online platforms selected for testing.

In step 240, a first set of metrics from the first targeted test with the control group is gathered from the online platforms by creative provider 101. These metrics include targeted individual impressions and responses thereto of the control creative by the targeted individuals identified in the control group. This includes metrics reported back from each online platform performing the targeted testing as well as any corresponding metrics tracked by the creative provider. In step 245, a second set of metrics from the second targeted test with the test group is gathered from the online platforms by creative provider 101. These metrics include targeted individual impressions and responses thereto of the test creative by the targeted individuals identified in the test group. This includes metrics reported back from each online platform performing the targeted testing as well as any corresponding metrics tracked by the creative provider.

In step 250, the metrics for each group are then compared towards determining whether there is a statistically significant difference between the responses of the control group (group A) and the test group (group B) towards determining whether those statistically significant differences identify which creative is the more effective creative for the targeted segment. It is possible that one creative may be more effective for all online providers or for only some of the online providers. Upon conclusion of the testing, gathering of metrics and subsequent statistical analysis, business decisions may be made, including whether or not to perform additional A/B testing.

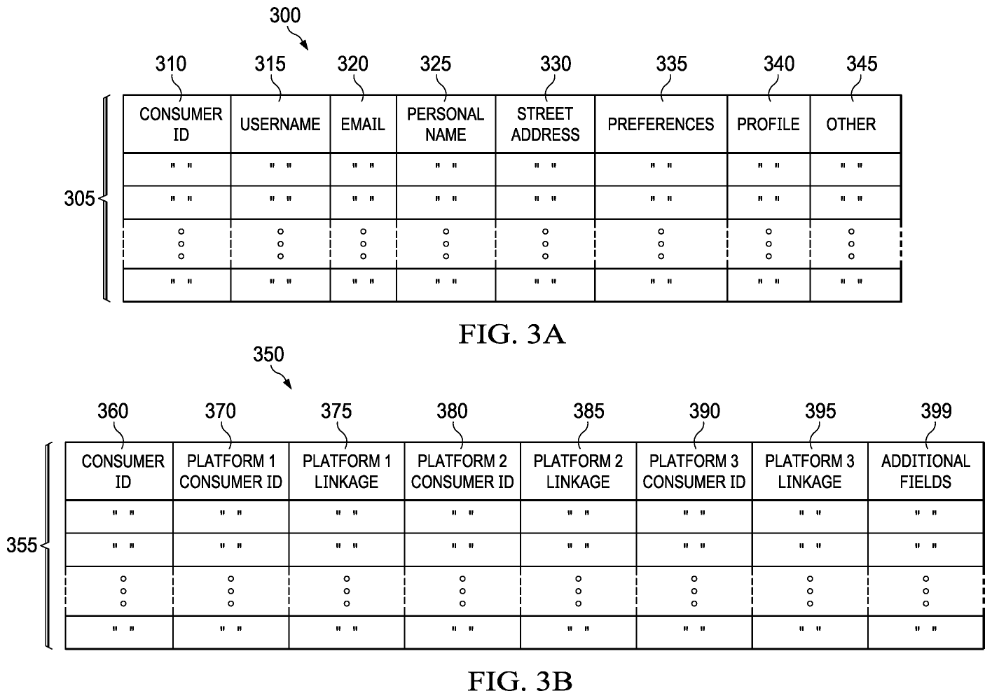

FIGS. 3A-3B depict block diagrams of a targeted individual database 300 and a targeted individual cross-index database 350, in which various embodiments of the present disclosure may be implemented. Targeted individual database 300 may be utilized for a variety of purposes including targeting advertising and for identifying populations and segments of populations for A/B testing as described herein. Cross-index database 350 may be utilized for cross-indexing multiple targeted individual databases including the targeted individual databases of service providers, online platforms, other creative providers, etc. FIGS. 3A and 3B are described herein with reference to corresponding elements of FIG. 1.

In the present embodiment, targeted individual database 300 corresponds to targeted individual database 102 for the online creative provider 101 of FIG. 1, although a similar targeted individual database may be utilized by a service provider or an online platform. Targeted individual database 300 includes multiple records 305, each record including several fields for each targeted individual in the present embodiment including a unique targeted individual ID 310, a username 315, an email address 320, a personal name 325, a street address 330, a set of preferences 335, additional profile information 340 and other types of information 345 specific to each targeted individual.

In the present embodiment, targeted individual database 300 includes a record 305 for each targeted individual that establishes a targeted individual relationship or otherwise registers with the online creative provider. Alternatively, the online creative provider may build a targeted individual database including targeted individuals which do not currently have an established targeted individual relationship with the online provider, but which the providing wishes to establish such a relationship through the use of advertising or other content including in a creative. In the present embodiment, a record is a set of information within a domain or database that establishes a relationship between a set of data or data elements. A record may be a separate entry into a database, a set of links between data, or other logical relationship between a set of data.

Targeted individual ID (identifier) 310 is a unique identifier for each targeted individual that the online provider has identified as either an existing targeted individual or a person for which the online provider wishes to establish a targeted individual relationship such as through the use of advertisements or other types of creatives. Targeted individual ID 310 may be utilized for a variety of purposes, including for linking cross-referenced targeted individuals in other targeted individual databases such as described below with reference to cross-index database 350. Username 315 is a username which the identified user may log onto a website of the online provider. This field (and some of the following fields) may be null for some targeted individuals, particularly those that have not established a relationship with the online provider. A password corresponding to the username may be stored in a separate secure database with encryption and other security techniques. Email address 320 is an email associated with the targeted individual. There may be more than one email address associated with a given targeted individual. Email address 320 may also be utilized as a username. Personal name 325 is a name of the targeted individual and may include a salutation or other pre-nominal letters, a first name, a middle name or middle initial, a last name, and any post-nominal letters. Personal name is shown here as a single field, but it may include multiple fields. Street address 330 includes a street address of the targeted individual including a first address line, a second address line, a city, a state or province, a zip code and a country. The format of street address 330 may vary depending on the country of the targeted individual. A targeted individual may have multiple addresses such as a home address and a mailing address. A set of preferences 335 may include privacy preferences, advertising preferences or other preferences of the targeted individual. Additional profile information 340 may include other profile information regarding the targeted individual such as profession, age, etc. that the online provider may have identified regarding the targeted individual. Other types of information 345 may include other types of information identified regarding the targeted individual such as online behavioral information which may have been identified through authorized monitoring behavior of the targeted individual on a website of the online provider. Alternative embodiments may include a variety or other or different information regarding each targeted individual in their targeted individual database or databases.

In the present embodiment, cross-index database 350 corresponds to cross-index database 103 of online creative provider 101 of FIG. 1, although a similar targeted individual database may be utilized by a service provider or an online platform. Cross-index database 350 includes multiple records 355, each record including several fields for each targeted individual in the present embodiment including a unique targeted individual ID 360, an online platform 1 targeted individual identifier 370, an online platform 1 targeted individual linkage 375, an online platform 2 targeted individual identifier 380, an online platform 2 targeted individual linkage 385, an online platform 3 targeted individual identifier 390, an online platform 3 targeted individual linkage 395, and additional fields 399.

In the present embodiment, targeted individual cross-index database 350 includes a record 355 for each targeted individual that establishes a targeted individual relationship or otherwise registers with the online creative provider. Alternatively, the online creative provider may build a targeted individual database including targeted individuals which do not currently have an established targeted individual relationship with the online provider, but which the providing wishes to establish such a relationship through the use of advertising or other content including in a creative. In the present embodiment, a record is a set of information within a domain or database that establishes a relationship between a set of data or data elements. A record may be a separate entry into a database, a set of links between data, or other logical relationship between a set of data.

Targeted individual ID (identifier) 360 is a unique identifier for each targeted individual that the online provider has identified as either an existing targeted individual or a person for which the online provider wishes to establish a targeted individual relationship such as through the use of advertisements or other types of creatives. Targeted individual ID 360 may correspond to targeted individual ID 310 of targeted individual database 300. That is, for a given targeted individual, there is a record in 305 targeted individual database 300 and a corresponding record 355 in targeted individual cross-index database 350, both using the same targeted individual ID for associating and cross-referencing between these databases. Online platform 1 targeted individual ID 370 includes a targeted individual identifier for the same targeted individual in targeted individual database 111 of online platform 110. Targeted individual linkage 375 includes data utilized to establish this cross-reference between targeted individual ID 360 and a targeted individual ID in targeted individual database 111. For example, if online platform 110 maintains an email address for each of its targeted individuals in its database, that email address may be utilized for identifying and associating the same targeted individual in cross-reference database 350. This linkage may be retained in cross-reference database 350 for maintenance of the database such as verification of targeted individual identity. As known to those of ordinary skill in the art, other types of targeted individual linkages may be utilized such as personal profile information (e.g., name and date of birth), mobile device identifiers (i.e., the targeted individual accesses both the creative provider and online platform using the same mobile device, the use of synchronizing cookies, etc. Online platform 2 targeted individual ID 380 includes a targeted individual identifier for the same targeted individual in targeted individual database 121 of online platform 120. Targeted individual linkage 385 includes data utilized to establish this cross-reference between targeted individual ID 360 and a targeted individual ID in targeted individual database 121. Online platform 3 targeted individual ID 390 includes a targeted individual identifier for the same targeted individual in targeted individual database 131 of online platform 130. Targeted individual linkage 375 includes data utilized to establish this cross-reference between targeted individual ID 360 and a targeted individual ID in targeted individual database 131. Additional fields 399 may be included in cross-reference database 350 to identify targeted individuals in other online providers, service providers, creative providers, etc.

Although targeted individual database 300 and cross-index database 350 are shown as separate databases associated with common targeted individual IDs, these databases could be combined into a common database such as a relational database. Alternative configurations of database(s) to store and maintain this type of information would be known to those of ordinary skill in the art. In an alternative embodiment, creative provider 101 may utilize a cross-index database of a service provider 150 or other online entity. Utilizing another entity's cross-reference database for cross-referencing targeted individuals may not require access to other entities' targeted individual identifiers, just an identification of which targeted individuals are cross-reference to certain other entities. For example, a service provider may be able to state that targeted individual ID 1234567 (using the creative provider's targeted individual ID) is cross-referenced in their cross-reference database to a targeted individual in an identified online provider. As known to those of ordinary skill in the art, other types of cross-referencing and linkages may be utilized in alternative embodiments.

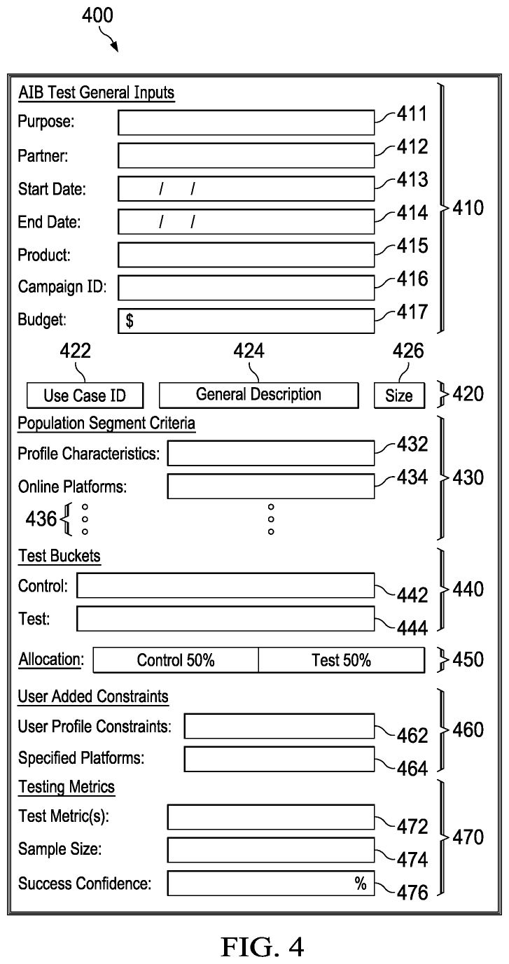

FIG. 4 depicts a diagram of a user interface 400 utilizing a use case for implementing an A/B test, in which various embodiments of the present disclosure may be implemented. FIG. 4 is described herein with reference to corresponding elements of FIG. 1. In this embodiment, a user completes a user interface template for performing an A/B test, including identifying a use case for implementing the A/B test. A use case may include a predefined segment of a population of targeted individuals which have been selected based on various criteria. A new use case may be developed for each advertising campaign. Alternatively, rather than developing a new use case for each for each A/B test, a predefined use case with a given population segment may be modified and/or supplemented by the user through user interface 400. A set of these use cases may be generated and stored in use case database 104 for such utilization. User(s) 107 may then utilize user interface 105 to implement A/B testing, thereby reducing the time and expertise needed by the user(s) for implementing such A/B testing such as described in greater detail below.

User interface 400 shown in FIG. 4 may include A/B test general inputs 410, use case identification 420, population segment criteria 430, test buckets 440, test bucket allocations 450, user added constraints 460 and testing metrics 470. Alternative embodiments may utilize different other types of user interfaces to gather then information needed to perform an A/B test efficiently. User interface 400 may be utilized by one or more authorized users to help initiate an A/B test for a test campaign.

Upon initiating an A/B test, a user may enter a variety of A/B test campaign general inputs 410 for running the A/B test. These general inputs may include a purpose of the A/B test 411, identification of any partner 412 (e.g., a service provider) which may assist with the A/B test, a start date 413 and an end date 414 for the A/B test, a product 415 affected by the A/B test, an identifier 416 of a campaign utilizing the A/B test, and a budget 417 for the A/B test. Alternative embodiments may utilize additional or different general inputs regarding the A/B test.

Use case identification 420 is general information identifying the use case for the present A/B test campaign. In use case identification 420, the user may select a new use case identifier from a pull-down menu 422 and enter a general description of the use case 424 and test population size 426. Alternatively, from pull-down menu 422, the user may select a preexisting use case identifier from a set of preexisting use cases stored in use case database 104. If a preexisting use case identifier is selected from pull-down menu 422, then that preexisting use case identifier may be automatically given a unique identifier extension to distinguish the present use case from the preexisting use case. In addition, if a preexisting use case identifier is selected from pull-down menu 422, then the corresponding general description 424 and population size 426 may be automatically filled in from use case database 104 by user interface 400. The user may then choose to modify general description 424 and population size 426 for the present use case.

Population segment criteria 430 includes the criteria previously utilized to generate the use case population segment including targeted individual profile characteristics 432, selected online platforms 434 that are cross-indexed for each targeted individual (i.e., targeted individuals that are identified and cross-indexed as being targeted individuals of the identified online platforms), and other criteria 436 utilized to identify the use case population segment (e.g. targeted individual location area). The user may enter this population segment criteria for a new use case. Alternatively, upon the selection of a use case in pull-down menu 422, the fields of population segment criteria 430 may be automatically filled in by user interface 400. The user may then choose to modify targeted individual profile characteristics 432, selected online platforms 434, and other criteria 436 for the present use case.

Test buckets 440 may be utilize to indicate the creatives to be used for each group of the upcoming A/B test campaign. That is, the user may indicate the control creative in control box 442 and the test creative in test box 444. In these boxes, the user may enter an internal link to a creative, provide a jpeg of a creative, provide high level code implementing or modifying a creative, or provide other data for identifying creatives to be utilized for each bucket of the A/B test. Test bucket allocations 450 are also displayed including the control group 452 and the test group 454. These may be fixed for a given use case and automatically filled in upon selection of a use case in pull-down menu 412. Alternatively, this may be a sliding scale that may be adjusted by the user by sliding the line separating control group 452 and test group 454 back and forth. Alternative embodiments may utilize different user interface tools to enable this capability. The user may also add additional constraints 460 to the use case to better define a targeted segment of the targeted individual population for the A/B test. This may include user profile constraints 462 such as the country where the user is located, specified online platforms with the same targeted individuals 464, etc.

Testing metrics 470 includes a set of metrics that the user may select to measure the success or lack thereof for each creative utilized in the A/B test. Some metrics may be gathered by each online platform displaying the creatives (e.g., whether the creative is displayed to the targeted individual, whether a targeted individual clicks on the creative for more information) or gathered by the creative provider (e.g., whether a targeted individual in either test group accesses or logs onto a website of the online platform). The user may select a metric or set of metrics utilizing a pull-down menu 472. The user may also provide other testing metrics such as sample size 474 and success confidence 476. That is, the user may request that the sample size of targeted individuals for the test be a percentage or fixed number of targeted individuals within the use case segment, such as to reduce the cost of the A/B test. When using a sample, the targeted individuals may then be randomly selected automatically from the use case segment. By providing a success confidence (e.g., 95%), the A/B test may be automatically stopped when that statistical confidence is reached in the test, thereby potentially providing quicker final results and reducing the cost of the A/B test. Other types of metrics and testing parameters may be utilized for user input in alternative embodiments. In addition, certain metrics and testing parameters may be set to a predefined value, which may or may not be modifiable by the user.

FIG. 5 depicts a block diagram 500 of a creative provider 501 in communication with online platforms and service providers, in which various embodiments of the present disclosure may be implemented. Creative provider 501 may communicate with multiple online platforms 510, 520 and additional online platforms 530 across communication channels 590. Creative provider 501 may also communicate with service provider 570 and additional service providers 580 across communication channels 590. Service provider 580 may then communicate with online platforms 540, 550 and 560 across communication channels 591. Additional service providers 580 may also communicate with other online platforms through additional communication channels. Creative provider 501, online platforms 510, 520, 530, 540, 550 and 560 as well as service providers 570 and 580 may communicate with a variety of online content targeted individuals across the internet or other network mediums, such as described with reference to FIG. 1 above. As described herein, targeted individuals are online users that may access or be otherwise view and interact with online content provided by online creative providers, service providers of online creative providers.

Communication channels 590 and 591 may be established across the internet or other types of online networks such as mobile phone networks, cable networks, or other network mediums. Communication channels 590 and 591 may be previously developed between the creative provider, online providers and service providers to allow for more tightly coupled secure communications such as to share information regarding targeted individual IDs, A/B test requests and A/B test results.

In addition to creative provider 501, online platforms 510, 520, 530, 540, 550 and 560 may also be creative providers to targeted individuals. For example, online platforms 510, 520, 530, 540, 550 and 560 may be social media platforms, search engine providers, other third party content and shopping providers, or other types of publishers providing content to targeted individuals. As a result, each online platform may have their own set of targeted individuals that are tracked in corresponding targeted individual databases 511, 521, 541, 551, etc. Each targeted individual database may track information specific to the corresponding online platform such as a unique identifier for that targeted individual, profile information for that targeted individual, and online activity information of that targeted individual for the corresponding online platform. For example, a social media platform may obtain targeted individual profile information directly from the targeted individual as well as track certain online preferences for that targeted individual. This information may be gleaned from the online activities of the targeted individual with the online platform as well as any other information which may be gleaned from the authorized use of cookies and other typical information gathering techniques known in the industry. Online platforms 510, 520, 530, 540, 550 and 560 may be considered independent from each other if they are owned and/or managed independently and they include separately managed targeted individual databases. Due to the use of cookies and other information gathering techniques, the online platforms may inevitably include some common targeted individuals and information about those targeted individuals despite being independently managed.

Online platforms 510, 520, 530, 540, 550 and 560 may also provide selected content to targeted individuals through advertising channels on behalf of other third party providers such as online creative provider 501. Such selected content may be advertisements or other type of content. One type of such content may be referred to herein as a creative. That is, a creative is content that promotes, sells, or otherwise brings attention to goods or services. Online creative provider 501 may also be a creative provider and maintain a targeted individual database 502 of its targeted individuals. Targeted individual database 502 may track information specific to the creative provider 501 such as a unique identifier for that targeted individual, profile information for that targeted individual, and online activity information of that targeted individual with creative provider 501.

Creative provider 501 may also maintain a cross-index database 503 includes information correlating targeted individuals among the various creative providers and online platforms. Cross-index database 503 may be developed over time through the authorized use of synchronizing cookies and other typical information gathering techniques known in the industry. Creative provider 501 may include a use case database 504, a user interface 505 for implementing A/B testing by user(s) 599, and a results database 506 for storing the results of the A/B testing. User(s) 599 may be user internal to creative provider 501, external suppliers working on behalf of creative provider 501, or other similarly authorized individuals. Use case database 504 may include a set of predefined use cases of population segments meeting certain criteria. A use case may be developed for each advertising campaign. Alternatively, rather than developing a new use case for each for each A/B test, a predefined use case with a given population segment may be modified and/or supplemented by user(s) 599 for utilization by subsequent A/B tests. A set of these use cases may be generated and stored in use case database 504 for such utilization. User(s) 599 may then utilize user interface 505 to implement A/B testing, thereby reducing the time and expertise needed by the user(s) for implementing such A/B testing such as described in greater detail below.

Service providers 570 and 580 may be providers that help provide linkages between creative providers and various online platforms. That is, creative provider 501 may request targeted advertising through service providers 570 and 580 to selected online platforms, such as online platforms 540, 550 and 560. Service providers 570 and 580 may be on-line ad placement agencies, demand—side platforms (DSPs) that links advertisers with publishers referred to as supply-side platforms (SSPs), tracking entities that can cross-correlate targeted individuals across multiple online platforms, etc. Service provider 570 may include a targeted individual database 571 that includes information about targeted individuals as well as a cross-index database 572 that correlates targeted individuals among the various creative providers and online platforms. This information may be utilized in enabling creative provider implementing A/B testing across multiple independent online platforms as described below. Service provider 580 may also similarly each include a targeted individual database and a cross-index database.

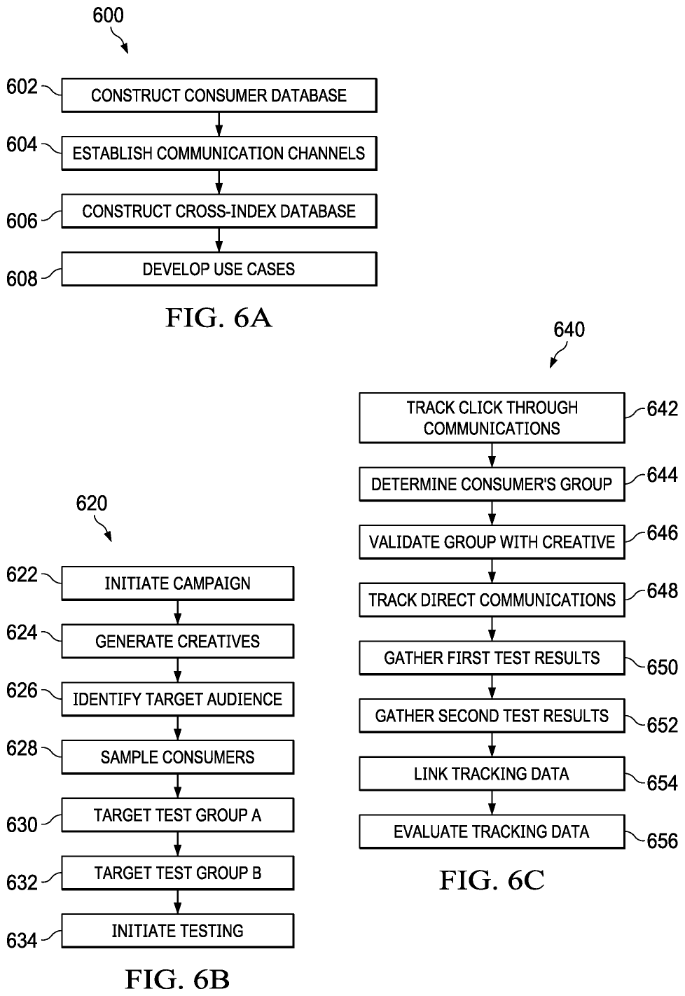

FIGS. 6A-6C depict flow diagrams of a creative provider managing and implemented A/B testing across multiple independent online platforms, in which various embodiments of the present disclosure may be implemented. FIGS. 6A-6C are described herein with reference to elements of FIGS. 4 and 5. These processes may be managed by user(s) 599 through user interface 505 utilizing use case database 504 and underlying targeted individual database 502 and cross-index database 503.

FIG. 6A depicts a flow diagram 600 of creative provider 501 developing and maintaining a platform for implementing A/B testing across multiple online platforms, in which various embodiments of the present disclosure may be implemented. In a first step 602, creative provider 501 may establish and construct a targeted individual database 502. Targeted individual database may include targeted individuals that have interacted directly with creative provider 501, or they may be targeted individuals identified by third parties that the creative provider desires to establish a relationship. Such a targeted individual database may include a unique targeted individual identifier for each targeted individual as well as a variety of information regarding each targeted individual such as location, interests, on-line activity, etc. This information regarding each targeted individual may be developed over time through prior interactions, directly or indirectly, with each targeted individual. As known by those of ordinary skill in the art, such information can be obtained through the use of authorized cookies, the use of a creative provider app by a targeted individual, etc. Such information regarding each targeted individual may allow for better segmentation of the targeted individuals for targeted advertising and testing thereof.

In a second step 604, creative provider 501 may establish communication channels 590 with a variety of online platforms and service providers. These communication channels may be established across the internet or other types of online networks such as mobile phone networks, cable networks, or other network mediums. Communication channels 590 may be previously developed between the creative provider, online providers and service providers to allow for more tightly coupled secure communications such as to share information regarding targeted individual IDs, A/B test requests and A/B test results.

In a third step 606, creative provider 501 may establish and construct targeted individual cross-index database 503. This may be accomplished through various techniques known to those of ordinary skill in the art including the use of cookie synchronization, a technique to map or otherwise cross-index user IDs from one system to another such as shown in FIG. 3B. Alternatively, such mapping or cross-indexing may be performed through direct communications between creative provider 501 and the various online platforms and service providers. In addition to cross-indexing targeted individuals, such mapping techniques may allow for further information gathering regarding targeted individuals that may be utilized to supplement targeted individual database 502.

In an optional fourth step 608, a set of use cases may be developed and stored in use case database 504 for subsequent use in A/B testing. That is, rather than developing a new use case for advertising campaign and associated A/B test, a predefined use case with a given population segment may be predefined for future use as described herein. A use case may include a predefined segment of a population of targeted individuals which have been selected based on various criteria. Such segmentation of the targeted individuals may allow for improved targeted advertising and A/B testing.

Once steps 602 through 608 are performed processing may continue to the processes described with reference to FIG. 6B below. Although steps 602 through 608 are shown in sequence, they may be performed in any order, including concurrently. In addition, steps 602 through 608 may be performed continuously or periodically for improved targeted advertising and A/B testing. Furthermore, although steps 602 through 608 are described with reference to creative provider 501, they may also be performed by a service provider. If performed by a service provider, some capabilities of the present embodiment may be performed on behalf of the creative provider, which may also allow for the service provider to maintain more security over the service provider's targeted individual information. As may be appreciate by one of ordinary skill in the art, alternative embodiments may utilize additional or alternative techniques or databases towards implementing the present or alternative embodiments.

FIG. 6B depicts a flow diagram 620 of creative provider 501 managing and initiating A/B testing across multiple independent online platforms in which various embodiments of the present disclosure may be implemented. This process may be managed by user(s) 599 through user interface 505 utilizing use case database 504 and underlying targeted individual database 502 and cross-index database 503.

In a first step 622, an online advertising campaign, or other campaign intending to generate a targeted individual response on selected online platforms 510, 520, 530, 540, 550 and/or 560, is initiated by creative provider 501. This online advertising campaign may be implemented directly from creative provider 501 to the online platforms, indirectly through service providers 570 and/or 580, or a combination thereof. This campaign may include a target audience of targeted individuals which meet a predetermined profile including certain predefined criteria such as age, prior online activity or lack thereof, etc. This campaign may also include a desired targeted individual response to the advertising campaign including certain quantifiable metrics such as the targeted individual clicking on the creative for additional information, the targeted individual buying or applying for certain goods, services or employment after viewing the creative, etc. This response by the targeted individual may be directly from or through any online platform that is displaying the creative to the targeted individual or it may be a separate response by the targeted individual directly to creative provider 501. Although the present embodiment is directed to initiating an online campaign, it may also be directed to improving or modifying an existing online campaign.

Then in step 624, a pair of test creatives, referred to herein as a control creative and a test creative, are generated or obtained by creative provider 501 for testing with a sample of the target audience for the desired targeted individual response. This may include two different advertisements to determine the more effective advertisement, variations of the same advertisement (e.g., different background colors, different voices, etc.) to determine the more effective variation, or even an advertisement and a placebo (e.g., a public service announcement and a test advertisement) to determine the overall effectiveness of the advertisement. If more than two creatives are intended for testing, then multiple A/B tests may be run concurrently with disjoint samples of the target audience.

In step 626, a target audience of targeted individuals, referred to herein as a targeted segment, is identified by creative provider 501. That is, the targeted segment of the population of targeted individuals meeting the predefined profile is identified based on certain predefined criteria from step 622. The targeted segment may also be further limited to those targeted individuals that are also in the targeted individual databases of the selected online platforms 510, 520, 530, 540, 550 and/or 560 as determined through the utilization of cross-index database 503. In the present embodiment, this targeted segment may be identified from targeted individual database 502 of creative provider 501. In an alternative embodiment, this targeted segment may be identified by utilizing the services of service providers 570 and/or 580 and their targeted individual databases and cross-index databases. Multiple targeted segments may be previously identified and stored as predefined segments.

In step 628, the targeted individuals identified in the targeted segment may be randomly sampled and segregated by creative provider 501 into two groups for the A/B testing. This sampling may include further filters on the targeted individuals such as limiting the sampling to targeted individuals in certain countries. In addition, the size and relative proportions of the sampling is also set forth by creative provider 501. For example, the creative provider may designate a sample size of 2000 targeted individuals in a 60/40 split between group A (also referred to herein as the control group) and group B (also referred to herein as the test group) resulting in a first set of 1200 targeted individuals in the control group and a disjoint set of 800 targeted individuals in the test group, the groups being disjoint sets of targeted individuals. The sample size and proportions may be determined based on the level of statistical significance sought for the A/B test as well as other factors such as described herein.

In step 630, creative provider 501 requests multiple selected online platforms 510, 520, 530, 540, 550 and/or 560 to perform a first targeted test of the targeted individuals identified in the control group (group A) with the control creative. This request may include instructions to track and provide back certain response metrics trackable by the corresponding online platforms. In this embodiment, cross-index database 503 may be utilized to identify individuals of the control group targeted individuals for each online platform receiving the first targeted test request. The request may also include a budget and a specified time frame for performing the requested test. As described above, an alternative embodiment may utilize service provider cross-index 572 for identifying identifiers of the control group targeted individuals for selected online platforms. In step 632, creative provider 501 also independently requests multiple selected online platforms 510, 520, 530, 540, 550 and/or 560 to perform a second targeted test of the targeted individuals identified in the disjoint test group (group B) with the test creative. This request may include instructions to track and provide back certain metrics trackable by the corresponding online platforms. In this embodiment, cross-index database 503 is utilized to identify individuals of the test group targeted individuals for each online platform receiving the second targeted test request. The request may also include a budget and a specified time frame for performing the requested test, concurrent with the timing of the test request of step 630. As described above, an alternative embodiment may utilize service provider cross-index 572 for identifying identifiers of the test group targeted individuals for selected online platforms. The request described in step 630 is communicated independently from the request described in step 632, but the first and second targeted tests are typically initiated concurrently with the same selected online platforms to help eliminate statistical variations caused by timing and the online platforms selected for testing.

In step 634, the online platforms may initiate the testing by providing the control creative to computer systems associated with the targeted individuals in the control group and providing the test creative to computer systems associated with the test group at the time periods set forth in steps 630 and 632 above. That is, when a targeted individual logs utilizes a computer system to access content provided by an online platform, the online platform may identify the accessing targeted individual as being in the control group or the test group. Upon such an identification, the online platform can then provide or otherwise impress the accessing targeted individual with the appropriate creative. As the targeted individuals in the control group and the test group view or are otherwise impressed with the corresponding creatives through their associated computer systems, the online platforms may track the impressions and responses thereto by the targeted individuals.

Once steps 622 through 634 are performed by or on behalf of creative provider 501, processing may continue to the processes described with reference to FIG. 6C below. Although steps 622 through 634 are shown in sequence, some of these steps may be performed in any order, including concurrently. For example, step 632 may be performed prior to step 630 whereby the targeted test of the test group (group B) may be requested prior the targeted test of the control group (group A) being requested. In addition, although steps 622 through 634 are described with reference to creative provider 501, some of the steps may also be performed by a service provider. If performed by a service provider, some capabilities of the present embodiment may be performed on behalf of the creative provider, which may also allow for the service provider to maintain more security over the service provider's targeted individual information. As may be appreciate by one of ordinary skill in the art, alternative embodiments may utilize additional or alternative techniques or databases towards implementing the present or alternative embodiments.

FIG. 6C depicts a flow diagram 640 of creative provider 501 managing the results of A/B testing across multiple independent online platforms in which various embodiments of the present disclosure may be implemented. The processes of FIG. 6C may initiate when the A/B test has been initiated at the online platforms requested to perform the tests.

In a first step 642, creative provider 501 tracks whether any members of the control group or test group targeted individuals click through or otherwise directly communicate with the creative provider through either a control or test creative. Such a click through or other communication may be established by the targeted individual clicking on a “more information” button or other interface embedded in a creative. This communication may be time stamped and stored in results database 506 with the corresponding targeted individual identifier and an indication of which creative the communicating targeted individual clicked through to online provider 501. Then in step 644, use case database 504 may be accessed to determine whether the communicating targeted individual from step 642 was in the control group or test group. In step 646, it is determined whether the communicating targeted individual belonged to the group that received the creative used to click through to the creative provider. If not, then there is an issue with implementation of the A/B test such that targeted individuals may be receiving the wrong creative, thereby possibly invalidating the A/B test. As a result, user(s) 599 may be alerted to the possible test invalidity for determining next steps, including whether to cancel the A/B test and identify the cause of the test invalidity. Otherwise, processing continues to step 648. In step 648, creative provider 501 tracks whether any members of the control group or test group targeted individuals access or otherwise communicate with the creative provider without clicking through a control or test creative. For example, a targeted individual may have viewed a test or control creative earlier in the day, then later accessed or communicated with the creative provider later in the day. This communication may be time stamped and stored in results database 506 with the corresponding targeted individual identifier and an indication of which group the targeted individual belonged to. This information may be useful as described below.

In step 650, a first set of response metrics from the first targeted test with the control group (group A) is gathered from the online platforms to creative provider 501. This first set of response metrics may be gathered continuously during the test, periodically during the test, or at the conclusion of the test. These response metrics include targeted individual impressions and responses thereto of the control creative by the targeted individuals identified in the control group. This includes metrics reported back from each online platform performing the targeted testing, any metrics reported back from each service provider from online platforms, as well as any corresponding metrics tracked by the creative provider itself. These response metrics may include tracking data regarding each targeted individual including a targeted individual ID (as known by the online provider) with a timestamp of when the creative was viewed and responded thereto by the targeted individual. The first set of response metrics may then be stored in results database 506. In step 652, a second set of response metrics from the second targeted test with the test group (group B) is gathered from the online platforms to creative provider 501. This second set of response metrics may be gathered continuously during the test, periodically during the test, or at the conclusion of the test. These response metrics include targeted individual impressions and responses thereto of the test creative by the targeted individuals identified in the test group. This includes metrics reported back from each online platform performing the targeted testing, any metrics reported back from each service provider from online platforms, as well as any corresponding metrics tracked by the creative provider itself. These response metrics may include tracking data regarding each targeted individual including a targeted individual ID (as known by the online provider) with a timestamp of when the creative was viewed and responded thereto by the targeted individual. The second set of response metrics may then be stored in results database 506.

In step 654, cross-index database 503 and use case database 504 may be accessed to link the tracking data regarding each targeted individual to either the control group or the test group. That is, each targeted individual ID provided in the tracking data may be utilized to identify the targeted individual ID as known by the creative provider in cross-index database 503, which is then utilized with use case database 504 to identify and link the tracking data to either the control group and the associated control creative or the test group and the associated test creative.

In step 656, the linked tracking data regarding each targeted individual may be accumulated, processed, and analyzed to evaluate the relative effectiveness of the control and test creatives in accordance with the testing metrics. That is, the tracking data for each group are then compared towards determining whether there is a statistically significant difference between the responses of the control group (group A) and the test group (group B) towards determining whether those statistically significant differences identify which creative is the more effective creative for the targeted segment. This analysis may be performed across all online platforms or for each online platform separately. That is, one creative may be more effective for some online platforms and another creative more effective for other online platforms. This analysis may be performed utilizing statistical techniques including a level of confidence in the results of the analysis. Such statistical analysis may include various techniques, such as utilization of the jackknife algorithm for confidence interval estimation, or other techniques which may be known to those of ordinary skill in the art.

Step 656 may be performed at the end of the requested testing, or it may be performing periodically or continuously during the requested testing. If performed before the end of the requested testing, if there is sufficient confidence in the test results, then the requested testing may be terminated early to reduce advertising costs and time needed to make an effectiveness determination. Such a termination may be made across all online platforms or on an online platform by online platform basis. Upon conclusion of the testing, gathering of results and subsequent statistical analysis, business decisions may be made including whether or not to perform additional A/B testing.

U.S. Provisional Patent Application No. 63/304,452, entitled “A Cross-Platform A/B Testing Framework for Offsite Advertising,” describes an exemplary embodiment of the multiple platform, multiple creative testing system and method and is incorporated by reference herein in its entirety.

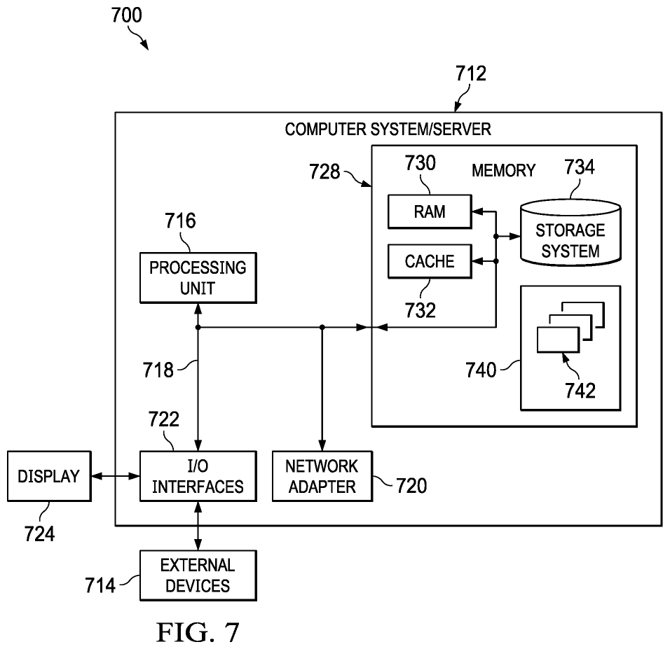

FIG. 7 depicts a block diagram of an illustrative data processing system in which various embodiments of the present disclosure may be implemented. Data processing system 700 is one example of a suitable data processing system and is not intended to suggest any limitation as to the scope of use or functionality of the embodiments described herein. Regardless, data processing system 700 is capable of being implemented and/or performing any of the functionality set forth herein such as managing and implementing an online A/B test across multiple independent online platforms.

In data processing system 700 there is a computer system/server 712, which is operational with numerous other computing system environments, peripherals, or configurations. Examples of well-known computing systems, environments, and/or configurations that may be suitable for use with computer system/server 712 include, but are not limited to, personal computer systems, server computer systems, thin clients, thick clients, hand-held or laptop devices, multiprocessor systems, microprocessor-based systems, set top boxes, programmable targeted individual electronics, network PCs, minicomputer systems, mainframe computer systems, and distributed cloud computing environments that include any of the above systems or devices, and the like.

Computer system/server 712 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 712 may be practiced in distributed computing environments where tasks are performed by remote processing devices that are linked through a communications network. In a distributed computing environment, program modules may be located in both local and remote computer system storage media including memory storage devices. For example, the present invention may be implemented in a cloud computing environment, distributed or otherwise, which may be virtualized such as with the use of a hypervisor managing multiple nodes including virtual processors, virtual memory, etc.

As shown in FIG. 7, computer system/server 712 in data processing system 700 is shown in the form of a general-purpose computing device. The components of computer system/server 712 may include, but are not limited to, one or more processors or processing units 716, a system memory 728, and a bus 718 that couples various system components including system memory 728 to processor 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 712 typically includes a variety of non-transitory computer system usable media. Such media may be any available media that is accessible by computer system/server 712, and it includes both volatile and non-volatile media, removable and non-removable media.

System memory 728 may include non-transitory computer system readable media in the form of volatile memory, such as random access memory (RAM) 730 and/or cache memory 732. Computer system/server 712 may further include other non-transitory removable/non-removable, volatile/non-volatile computer system storage media. By way of example, storage system 734 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 718 by one or more data media interfaces. Memory 728 may include at least one program product having a set (e.g., at least one) of program modules that are configured to carry out the functions of the embodiments. Memory 728 may also include data that will be processed by a program product.

Program/utility 740, having a set (at least one) of program modules 742, may be stored in memory 728 by way of example, and not limitation, as well as an operating system, one or more application programs, other program modules, and program data. Each of the operating system, one or more application programs, other program modules, and program data or some combination thereof, may include an implementation of a networking environment. Program modules 742 generally carry out the functions and/or methodologies of the embodiments. For example, a program module may be software for managing and implementing an online A/B test across multiple independent online platforms.

Computer system/server 712 may also communicate with one or more external devices 714 such as a keyboard, a pointing device, a display 724, etc.; one or more devices that enable a user to interact with computer system/server 712; and/or any devices (e.g., network card, modem, etc.) that enable computer system/server 712 to communicate with one or more other computing devices. Such communication can occur via I/O interfaces 722 through wired connections or wireless connections. Still yet, computer system/server 712 can communicate with one or more networks such as a local area network (LAN), a general wide area network (WAN), and/or a public network (e.g., the Internet) via network adapter 720. As depicted, network adapter 720 communicates with the other components of computer system/server 712 via bus 718. It should be understood that although not shown, other hardware and/or software components could be used in conjunction with computer system/server 712. Examples, include, but are not limited to: microcode, device drivers, tape drives, RAID systems, redundant processing units, data archival storage systems, external disk drive arrays, etc.

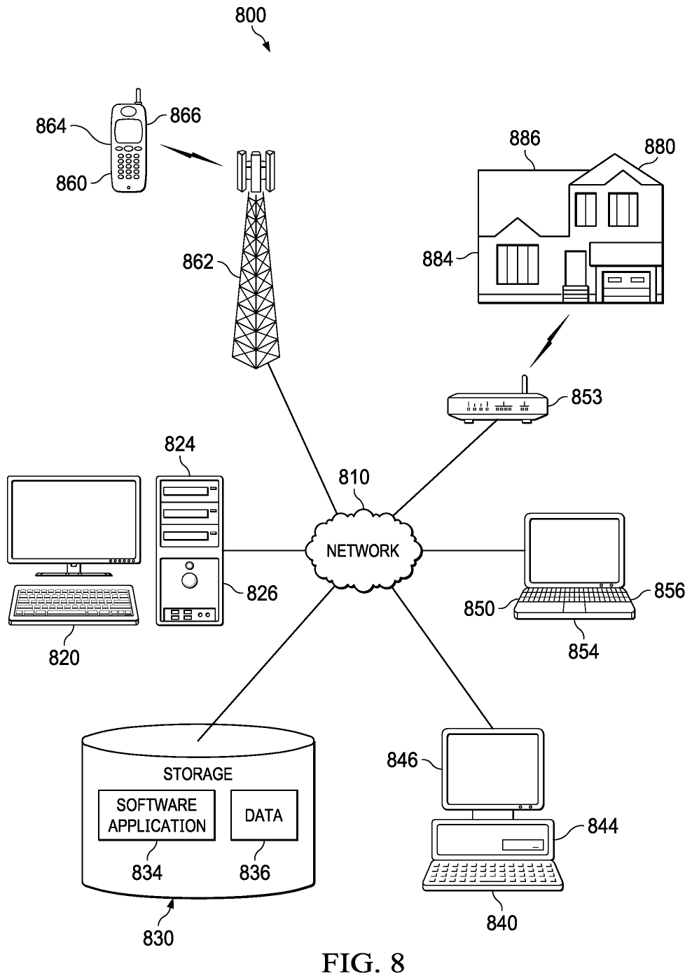

FIG. 8 depicts a block diagram of an illustrative network of data processing systems in which various embodiments of the present disclosure may be implemented. Data processing environment 800 is a network of data processing systems such as described above with reference to FIG. 7. Software applications such as for managing and implementing an online A/B test across multiple independent online platforms may be processed on any computer or other type of data processing system in data processing environment 800. Data processing environment 800 includes network 810. Network 810 is the medium used to provide simplex, half duplex and/or full duplex communications links between various devices and computers connected together within data processing environment 800. Network 810 may include connections such as wire, wireless communication links, or fiber optic cables.

Server 820 and client 840 are coupled to network 810 along with storage unit 830. In addition, laptop 850 and facility 880 (such as a home or business) are coupled to network 810 including wirelessly such as through a network router 853. A mobile device 860 such as a mobile phone may be coupled to network 810 through a cell tower 862. Data processing systems, such as server 820, client 840, laptop 850, mobile device 860 and facility 880 contain data and have software applications including software tools processing thereon. Other types of data processing systems such as personal digital assistants (PDAs), smartphones, tablets and netbooks may be coupled to network 810.

Server 820 may include software application 824 and data 826 for managing and implementing an online A/B test across multiple independent online platforms or other software applications and data in accordance with embodiments described herein. Storage 830 may contain software application 834 and a content source such as data 836 for managing and implementing an online A/B test across multiple independent online platforms. Other software and content may be stored on storage 830 for sharing among various computer or other data processing devices. Client 840 may include software application 844 and data 846. Laptop 850 and mobile device 860 may also include software applications 854 and 864 and data 856 and 866. Facility 880 may include software applications 884 and data 886 on local data processing equipment. Other types of data processing systems coupled to network 810 may also include software applications. Software applications could include a web browser, email, or other software application for managing and implementing an online A/B test across multiple independent online platforms.

Server 820, storage unit 830, client 840, laptop 850, mobile device 860, and facility 880 and other data processing devices may couple to network 810 using wired connections, wireless communication protocols, or other suitable data connectivity. Client 840 may be, for example, a personal computer or a network computer.

In the depicted example, server 820 may provide data, such as boot files, operating system images, and applications to client 840 and laptop 850. Server 820 may be a single computer system or a set of multiple computer systems working together to provide services in a client server environment. Client 840 and laptop 850 may be clients to server 820 in this example. Client 840, laptop 850, mobile device 860 and facility 880 or some combination thereof, may include their own data, boot files, operating system images, and applications. Data processing environment 800 may include additional servers, clients, and other devices that are not shown.

In the depicted example, data processing environment 800 may be the Internet. Network 810 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 800 also may be implemented as a number of different types of networks, such as for example, an intranet, a local area network (LAN), or a wide area network (WAN). FIG. 8 is intended as an example, and not as an architectural limitation for the different illustrative embodiments.

Among other uses, data processing environment 800 may be used for implementing a client server environment in which the embodiments may be implemented. A client server environment enables software applications and data to be distributed across a network such that an application functions by using the interactivity between a client data processing system and a server data processing system. Data processing environment 800 may also employ a service oriented architecture where interoperable software components distributed across a network may be packaged together as coherent business applications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for managing and implementing an online A/B test across multiple independent online platforms. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of performing testing of at least first and second creatives across multiple, independent online platforms, the method comprising:
sending the first and second creatives for distribution across the multiple, independent online platforms;
sending a first request to each of the online platforms to provide the first creative only to computer systems associated with individuals of a first test group set;
sending a second request to each of the online platforms to provide the second creative only to computer systems associated with individuals of a second test group set, wherein the first test group set and the second test group set are disjoint and the first request is independent of the second request;
receiving responses to the first and second creatives;
receiving tracking data that links each response to one of the individuals in either the first test group set or the second test group set;
for each of the responses, processing the tracking data to generate a link between each individual and either the first creative or the second creative; and
evaluating the linked responses to determine an effectiveness of the first and second creatives.

2. The method of claim 1 further comprising sending the first and second creatives, the first request and the second request to a service provider for distribution to multiple independent online platforms.

3. The method of claim 1 further comprising sending the first and second creatives, the first request and the second request directly to multiple, independent online platforms.

4. The method of claim 1 wherein the responses to the first and second creatives are interactions with the first and second creatives from individuals of the first and second test group sets.

5. The method of claim 4 further comprising reviewing the responses to determine whether each individual in the first group set is interacting with the first creative and whether each individual in the second test group set is interacting with the second creative; and upon a negative determination generating a notification of the negative determination.

6. The method of claim 4 wherein the responses to the first and second creatives include multiple types of responses indicating a level of an interaction by the individuals with the creatives.

7. The method of claim 1 wherein evaluating the linked responses includes determining an effective of the first and second creatives for each online platform.

8. A computer program product for performing A/B testing of first and second creatives across multiple, independent online platforms, the computer program product comprising a computer readable storage medium having program instructions embodied therewith, the program instructions processed by a processing circuit to cause the device to perform a method comprising the steps of: sending the first and second creatives for distribution across the multiple, independent online platforms;
sending the first and second creatives for distribution across the multiple, independent online platforms;
sending a first request to each of the online platforms to provide the first creative only to computer systems associated with individuals of a first test group set;
sending a second request to each of the online platforms to provide the second creative only to computer systems associated with individuals of a second test group set, wherein the first test group set and the second test group set are disjoint and the first request is independent of the second request;
receiving responses to the first and second creatives;
receiving tracking data that links each response to one of the individuals in either the first test group set or the second test group set;
for each of the responses, processing the tracking data to generate a link between each individual and either the first creative or the second creative; and
evaluating the linked responses to determine an effectiveness of the first and second creatives.

9. The computer program product of claim 8 further comprising sending the first and second creatives, the first request and the second request to a service provider for distribution to multiple independent online platforms.

10. The computer program product of claim 8 further comprising sending the first and second creatives, the first request and the second request directly to multiple, independent online platforms.

11. The computer program product of claim 8 wherein the responses to the first and second creatives are interactions with the first and second creatives from individuals of the first and second test group sets.

12. The computer program product of claim 11 further comprising reviewing the responses to determine whether each individual in the first group set is interacting with the first creative and whether each individual in the second test group set is interacting with the second creative; and upon a negative determination generating a notification of the negative determination.

13. The computer program product of claim 11 wherein the responses to the first and second creatives include multiple types of responses indicating a level of an interaction by the individuals with the creatives.

14. The computer program product of claim 1 wherein evaluating the linked responses includes determining an effective of the first and second creatives for each online platform.

15. A data processing system for performing A/B testing of first and second creatives across multiple, independent online platforms, the data processing system comprising:
a processor; and
a memory storing program instructions which when processed by the processor perform the steps of:
sending the first and second creatives for distribution across the multiple, independent online platforms;
sending a first request to each of the online platforms to provide the first creative only to computer systems associated with individuals of a first test group set;
sending a second request to each of the online platforms to provide the second creative only to computer systems associated with individuals of a second test group set, wherein the first test group set and the second test group set are disjoint and the first request is independent of the second request;
receiving responses to the first and second creatives;
receiving tracking data that links each response to one of the individuals in either the first test group set or the second test group set;
for each of the responses, processing the tracking data to generate a link between each individual and either the first creative or the second creative; and
evaluating the linked responses to determine an effectiveness of the first and second creatives.

16. The data processing system of claim 15 further comprising sending the first and second creatives, the first request and the second request to a service provider for distribution to multiple independent online platforms.

17. The data processing system of claim 15 further comprising sending the first and second creatives, the first request and the second request directly to multiple, independent online platforms.

18. The data processing system of claim 15 wherein the responses to the first and second creatives are interactions with the first and second creatives from individuals of the first and second test group sets.

19. The data processing system of claim 18 further comprising reviewing the responses to determine whether each individual in the first group set is interacting with the first creative and whether each individual in the second test group set is interacting with the second creative; and upon a negative determination generating a notification of the negative determination.

20. The data processing system of claim 18 wherein the responses to the first and second creatives include multiple types of responses indicating a level of an interaction by the individuals with the creatives.
